(19) United States
(12) Patent Application Publication
(10) Pub. No.: US 2009/0265215 A1
(43) Pub. Date: Oct. 22, 2009

(54) Methods and apparatus to monitor audience exposure to media using duration-based data

(76) Inventor: Paul Bernhard Lindstrom, Briarcliff Manor, NY (US)

Correspondence Address: Hanley, Flight & Zimmerman, LLC, 150 S. Wacker Dr. Suite 2100, Chicago, IL, 60606, US

(21) Appl. No.: 12/148,769

(22) Filed: Apr. 22, 2008

(51) Int. Cl. G06Q 10/00

(52) U.S. Cl. 705/10

(57) ABSTRACT

Example methods, apparatus, and articles of manufacture to monitor audience exposure to media using duration-based data are disclosed. A disclosed example method involves determining a duration of exposure to an information medium based on transaction information associated with access to a public establishment, determining a first duration value based on the duration of exposure, and determining a second duration value indicative of a duration for which the information medium is accessible within the public establishment. The example method also involves determining an exposure performance value based on the first and second duration values indicative of an exposure performance of the information medium.

### FIELD OF THE DISCLOSURE

The present disclosure relates generally to monitoring media audiences and, more particularly, to methods and apparatus to monitor audience exposure to media using duration-based data.

### BACKGROUND

Product manufacturers, service providers, advertisers, and retail establishments are often interested in the amount of consumer exposure to advertisement and/or informational media. Known techniques for monitoring consumer exposure to advertisements include conducting surveys, counting consumers, and/or quantifying amounts of traffic that pass by advertisements. To develop such surveys and to correlate passerby traffic with advertisement content, the accuracy of the recorded information about the advertisements of interest directly affects the meaningfulness of the exposure study results.

In some instances, a media research company can recruit panel members that are surveyed or tracked to determine advertisement/informational media to which each panel member was exposed. For example, if a panel member indicates that he or she visited a particular area, it may be concluded that the panel member was exposed to an advertisement or signage displayed in that area. The survey results or location tracking information can then be processed to determine the number of exposure instances for each advertisement or signage that is part of a media research study. The panel member exposures can then be used to infer the number of exposures to the generic public for each advertisement or signage. These exposure numbers can be used by product manufacturers, service providers, and advertisers to better market their products.

### BRIEF DESCRIPTION OF THE DRAWINGS

FIG. 1 illustrates a plan view of an example fitness environment having different areas, each of which includes respective advertisement/informational media for which audience exposure can be measured using the example methods and apparatus described herein.

FIG. 2 illustrates a plan view another example environment depicted as a bar/dining establishment having advertisement/informational media for which audience exposure can be measured using the example methods and apparatus described herein.

FIG. 3 illustrates a plan view of another example environment depicted as an entertainment venue for which audience exposure to advertisement/informational media can be measured using the example methods and apparatus described herein.

FIG. 4 illustrates another example environment depicted as a gasoline station having an advertisement/informational medium for which audience exposure can be measured using the example methods and apparatus described herein.

FIG. 5 depicts an example data structure that may be used to store data to measure exposures to advertisement/informational media.

FIG. 6 depicts another example data structure that may be used to store data to measure weighted exposures to advertisement/informational media.

FIG. 7 depicts a block diagram of an example apparatus that may be used to measure audience exposure to advertisement/informational media.

FIG. 8 is a flow diagram representative of machine readable instructions that may be executed to implement the example apparatus of FIG. 7 to measure audience exposure to advertisement/informational media.

FIG. 9 is another flow diagram representative of machine readable instructions that may be executed to implement the example apparatus of FIG. 7 to measure audience exposure to advertisement/informational media.

FIG. 10 is a block diagram of an example processor system that may be used to implement some or all of the example methods and apparatus described herein.

### DETAILED DESCRIPTION

Although the following discloses example methods and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, or in any combination of hardware and software. Accordingly, while the following describes example methods and apparatus, persons having ordinary skill in the art will readily appreciate that the examples provided are not the only way to implement such methods and apparatus.

The example methods and apparatus described herein may be implemented by a consumer metering entity, by retail businesses, or by any other entity interested in collecting and/or analyzing information to meter audience exposure to advertisement media and/or informational media using duration-based data. Product manufacturers, service providers, and advertisers are often interested in the exposure performance of their advertisement and/or informational media. Advertisement and/or informational media types can include, for example, posters, murals, dynamically changing boards (e.g., electronic boards, scrolling boards, etc.), video monitors, billboards, or any other media that may be used to convey information including, for example, advertisements. In the illustrated examples described herein, advertisement/informational media can include publicly located media or media presented in public areas or establishments or areas that are accessible by persons that extend beyond familial members of a household. In some instances public areas or establishments may include places that require memberships or admission tickets/passes such as, for example, fitness centers, amusement parks, sporting clubs, etc. However, in other example implementations, the example methods and apparatus described herein can be implemented in connection with advertisement/informational media presented and/or displayed in other types of places including household environments.

Measuring audience exposure to media can be used to assess the performance of different media located in different places. For example, the example implementations described herein may be used to determine the comparative performances between different advertisement/informational media of the same media type or of different media types. In addition, the metering example methods and apparatus can be used to assess the efficiency of different advertisement/informational media located in different places by measuring the amount of actual audience exposure to a medium and comparing the actual exposure to the potential audience exposure to the medium.

The example methods and apparatus described herein are implemented using traffic-related transactional data to measure duration-based (time-based) media exposure. Traffic-related transactional data can be information indicative of consumer activity related to indoor/outdoor locations and can include, for example, sales transaction data, card member swipes at fitness centers (or other membership establishments), ticket validation transactions at airline establishments (or other consumer transportation establishments), patron counts at eateries or drinking establishments, turnstile count data (or any other people count data) at commercial or retail establishments (e.g., entertainment venues, amusement parks, sports arenas/stadiums, grocery stores, clothing stores, department stores, etc.), gas pump transactions, data indicative of access or activities in public facilities, etc.

Duration-based media exposure can be determined using predetermined typical durations of exposures associated with different types of transactions or activities. For example, a predetermined duration of exposure for a typical person that has an airline ticket or boarding pass validated at an airport gate may be determined to be thirty minutes if it is found that a typical airline passenger waits at an airport gate for about thirty minutes before boarding an airplane. In this manner, the example methods and apparatus described herein can use the predetermined 30-minute duration to determine that an airline passenger corresponding to a ticket validation transaction was exposed for 30-minutes to each advertisement media located and/or presented within the area and/or proximity of the airport gate. For instances in which advertisements are presented in a time-based alternating manner (e.g., periodically or aperiodically changing or updated video advertisements, scrolling advertisements, electronic advertisements, etc.) for repeatedly short periods, the 30-minute duration per airline ticket validation transaction indicates that a corresponding airline passenger had a 30-minute opportunity to be exposed to each of the dynamically changing advertisements. For example, if a 30-second advertisement is presented once every 15 minutes, then the airline passenger was likely to have been exposed twice to that advertisement while waiting at the airport gate for 30 minutes.

The example methods and apparatus described herein may also be used to measure the performance or efficiency of different advertisement/informational media by determining exposure efficiency measures of those media. As discussed in greater detail below, a medium's exposure performance can be measured based on the total actual duration of exposure attributed to the medium corresponding to all people actually exposed to the medium and the duration for which the advertisement is available or accessible for potential exposure. In the illustrated examples described herein, the total actual duration of exposure can be determined using the transactional data described above. Using the airport gate example again for purposes of illustration, the total actual duration of exposure during a twenty-four hour period for all airline passengers that had their airline tickets or boarding passes validated at a particular gate in which an advertisement/informational medium of interest is located can be determined by multiplying thirty minutes (assuming the typical airline passenger spends thirty minutes waiting at a gate prior to boarding a plane) by the ticket/pass validation count. The total potential duration of exposure for the advertisement/informational medium of interest can be set equal to the amount of time for which the airport gate is used for boarding passengers during a 24-hour period. For example, if the airport gate is only used for twelve hours per day, then the potential duration of exposure is 720 minutes. The exposure performance or efficiency of the advertisement/informational medium at the airport gate can then be determined based on the total actual duration of exposure and the potential duration of exposure.

In some example implementations, the example methods and apparatus can be implemented in connection with survey response data. That is, survey questionnaires can be used to obtain information indicative of the meaningfulness of people's transactions relative to media exposure time. For instance, a person represented by a transaction (e.g., an airline ticket validation, a membership card swipe, a sales transaction receipt, etc.) may not actually be exposed to an advertisement/informational medium of interest if the person was not paying attention to and/or was not within exposure proximity to the medium. For example, the person may be engrossed in a book, a magazine, work, a conversation, sleep, etc. or the person may relocate to a different area from which the advertisement/informational medium is not accessible for exposure to the person. Thus, even though a media exposure metering entity implementing the example methods and apparatus described herein has predetermined that a person corresponding to a recorded transaction spends a typical duration attributable to media exposure, such typical duration is not applicable to persons that are not actually exposed to the media. To account for such instances, the example methods and apparatus described herein can use surveys designed to assess whether people were actually exposed to advertisement/informational media to detect non-exposure and/or partial-exposure transactions.

In some instances, surveys may also be used to determine or estimate transactions. For example, a survey may be designed to receive responses indicative of how many times per week, per month, etc. a person visits or visited a particular establishment. Each visitation can then be used to represent a transaction instance, and the transaction instances can be used to determine durations of exposure to one or more advertisement/informational media presented in the establishment.

By analyzing media exposure based on duration of exposure, the example methods and apparatus described herein can be used to compare exposure data across different advertising networks (e.g., advertisement space providers that own video monitors, poster space, etc., lease advertisement space, and present advertisements on that space) and advertising vehicles. Further, the example methods and apparatus can be used to analyze the exposure data in a comparative manner with exposure data of traditional advertisement systems (e.g., television advertising systems, radio advertising systems, etc.). That is, comparative exposure performance or efficiency values can be determined using ratios of total actual exposure versus potential exposure. These ratios of exposure performance can be compared to exposure performance values of traditional advertisement systems. Also, audience exposure durations to television-based and radio-based advertisements presented in a home can be measured based on the durations or runtime of the advertisements because people typically stay tuned to the advertisements to continue watching or listening to a scheduled program of interest. On the other hand, traditional techniques of measuring exposures to non-television and non-radio advertising involve counting the number of people that walked by, moved past, or were in the vicinity of an advertisement such as, for example, a billboard, a poster, a mural, or any other publicly displayed medium without taking into account a dwell time or duration of stay of each person. Thus, traditional exposure measurement information associated with non-television and non-radio advertisements and collected using traditional techniques are not readily comparable to traditional exposure measurement information associated with television-based and radio-based advertisements because, while television/radio-based exposure measurements can be duration-based exposure measurements based on the run-time of the advertisements, traditional non-television/non-radio exposure measurements are not duration-based. The example methods and apparatus described herein facilitate comparative analyses of exposure measurement information of television/radio-based advertisements and non-television/non-radio-based advertisements by quantifying the dwell times or exposure durations of each person detected as walking by, moving past, or being in the vicinity of the non-television/non-radio-based advertisements.

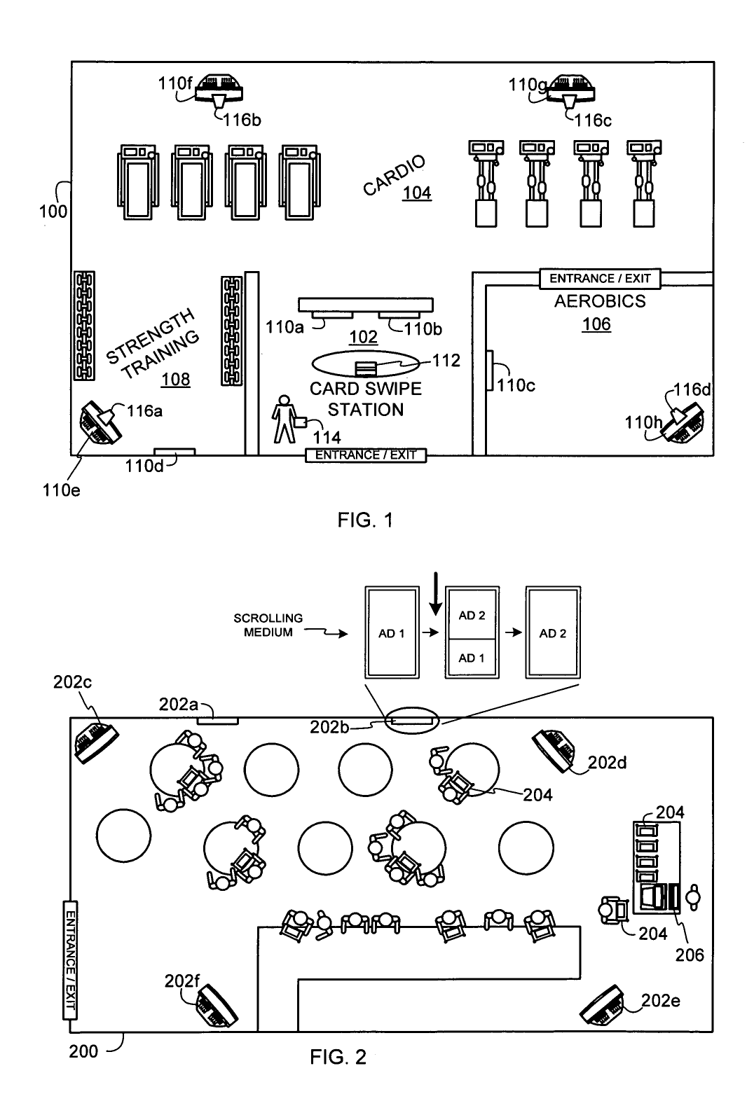

Other example environments for which the example methods and apparatus described herein may be implemented are described below in connection with FIGS. 1-4. In addition, further aspects and features of the example methods and apparatus are described below in association with the illustrated figures. While FIGS. 1-4 depict specific environments (a fitness environment, a bar/dining establishment, an entertainment venue, and a gasoline station), the example methods and apparatus described herein are not limited to such environments. Instead, the illustrated environments of FIGS. 1-4 are merely illustrative and are provided to describe example implementations, aspects, and applications of the example methods and apparatus. In addition, although certain techniques of determining duration of audience exposure to media are described in connection with specific ones of the environments depicted in FIGS. 1-4, it should be understood that such techniques may be used in connection with other ones of the environments of FIGS. 1-4 and environments not depicted in FIGS. 1-4. Also, each of the techniques described below for determining durations of exposure can be compartmentalized into different day parts (e.g., morning, afternoon, evening, night) by basing the below described calculations on transaction data corresponding to particular ones of the day parts.

Turning to FIG. 1, an example fitness environment 100 includes a foyer 102, a cardio room 104, an aerobics room 106, and a strength training room 108. Each of the areas 102, 104, 106, and 108 includes respective advertisement/informational media 110a-110h. In the illustrated example, the advertisement/informational media 110a-h are video delivery media 110a-h that can be used to present video/audio-based advertisements/information. The fitness environment also includes a card swipe station 112 in the foyer 102 for use by members to swipe their membership cards 114 when entering and/or leaving the fitness environment 100. To track the number of people that visited the fitness environment 100 during a specified period, each membership card swipe corresponding to a person entering the fitness environment 100 can be recorded as a transaction. In addition, to determine the number of people present in any of the areas 104, 106, and 108 at any given time, one or more people counters 116a-d are provided in each of the areas. The people counters 116a-d can be implemented using any suitable technology including imaging technologies, radar technologies, RFID technologies, user-input technologies, etc. and may be positioned anywhere in or proximate to the areas 104, 106, and 108.

In some example implementations, the people counters 116a-d may be used in other environments for generating people count transaction data. For example, people counters substantially similar or identical to the people counters 116a-d could be placed in retail establishments proximate to advertisement/informational medium to determine the number of people that were exposed to that medium. Additionally or alternatively, people counters could be placed in entryway or exitways of establishments to count the number of people that visited the establishment. In some example implementations, the people counters 116a-d could be replaced by human counters or in-person agents that are instructed to periodically or aperiodically manually count people in different locations. For example, in the context of the fitness environment 100, a person could be instructed to count the number of people in each of the areas 102, 104, 106, and 108 at particular intervals. In yet other example implementations, instead of or in addition to using the people detectors 116a-d and/or human counters, count transaction data could be obtained using survey questionnaires designed to obtain information from people on the number of times that they visited a particular location.

In the illustrated example, the card swipe station 112 can be used to collect transactions to determine the total number of people that visited the fitness environment 100, while the people counters 116a-d can be used to count the number of people present at each of the areas 104, 106, and 108. In the illustrated example, each person count associated with each one of the areas 104, 106, and 108 is representative of one transaction indicative of a corresponding person using, and thus, dwelling in that one of the areas 104, 106, and 108. The transactions collected using the card swipe station 112 can be used to determine the number of people that walked through the foyer 102, and thus, were exposed to the media 110a-b. The people counts collected using the people counters 116a-d may be used to determine the number of people that were exposed to each of the media 110a-h.

In some example implementations, in addition to or instead of using the card swipe station 112 and/or the people counters 110a-h, surveys may be used to collect information indicative of how many people visit the fitness environment 100 within a given time period. For example, a survey may be designed to collect responses indicative of how many times in a seven-day week people visit the fitness environment 100.

In any case, whether transaction data is collected using the card swipe station 112, the people counters 116a-d, and/or survey questionnaires, durations of media exposure can be determined based on people's frequencies of visitation. For example, if a person visits the fitness environment 100 seven days in a seven-day week, the person's frequency of exposure would be higher than a person that only visits once or twice per seven-day week.

To determine the duration of exposure to each of the media 110a-h, a metering entity may provide a predetermined typical duration of stay or dwell time for a typical person that visits the fitness environment 100. In some example implementations, different predetermined typical durations or dwell times may be provided for each of the different areas 102, 104, 106, and 108 of the fitness environment. For example, a predetermined typical dwell time of a person in the foyer 102 may be thirty seconds, while a predetermined typical dwell time of a person in the cardio area 104 may be thirty minutes. The predetermined typical durations of stay or dwell times can be determined based on responses to survey questionnaires via which people are asked to provide the amounts of times they spent in particular ones of the areas 102, 104, 106, and 108 during one or more typical exercise sessions. This technique for determining predetermined typical durations of stay or dwell times may be used in connection with any other environments described below in connection with FIGS. 2-4 and or any other environment for which the example methods and apparatus described herein are used to monitor audience exposure to media. In the illustrated example of FIG. 1, the predetermined typical dwell times or durations of stay can be used in connection with transaction data collected using the card swipe station 112, the people counters 116a-d, and/or survey questionnaires to determine durations of exposure to the media 110a-h.

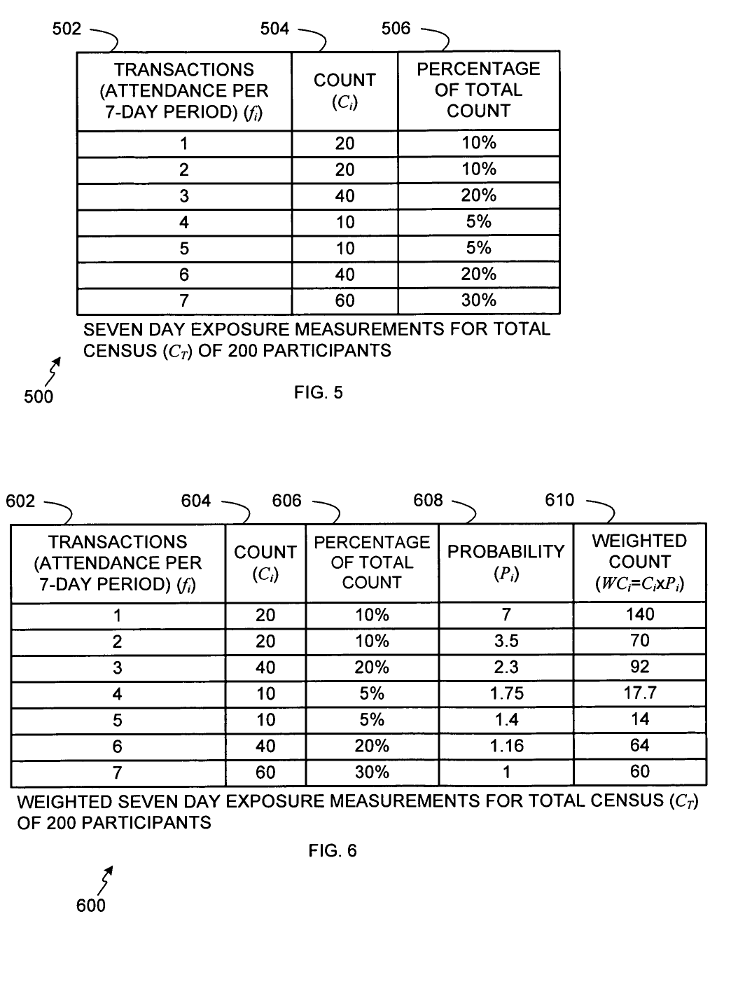

An illustrative example implementation that can be used to determine people's frequencies of visitation to the fitness environment 100 and durations of exposures to media in the fitness environment 100 is described below in connection with the tables or data structures 500 and 600 of FIGS. 5 and 6. Turning to the example table 500 of FIG. 5, a transactions column 502 stores the number of visitation frequencies (fᵢ) possible per person in a seven-day period and a count column 504 stores the quantity of people or people count (Cᵢ) that visit the fitness environment for corresponding visitation frequencies in the transactions column 502. The count data (Cᵢ) stored in the count column 504 in the illustrated example is taken from a total census of 200 people. A percentage of total count column 506 stores the percentage representation of each count value in the count column 504 relative to the total census count of 200 people.

The data stored in the table 500 can be processed to determine the average visitation frequency (f_{avg}) of the typical person in the total 200-count census based on equation 1 below.

$${f}_{avg} = \frac{{\sum }_{i = 1}^{n} {f}_{i} \times {C}_{i}}{{C}_{T}} \qquad Equation 1$$

The average visitation frequency (f_{avg}) of equation 1 is representative of the visitation frequencies of all people at any point in time without giving different weights to any one person's frequency of visitation. As shown in equation 1 above, the sum of the products of the visitation frequencies (fᵢ) multiplied by the counts (Cᵢ) for each of the seven days (n=7) in the seven day period of transactions is divided by the total census count (C_{T}). Using the data in the illustrated example of FIG. 5, the average visitation frequency (f_{avg}) is equal to 4.65. The average visitation frequency (f_{avg}) can then be multiplied by a predetermined typical dwell time or duration of exposure (Dₚ) as shown in Equation 2 below to determine a per-person duration of media exposure (Dₘ).

Dₘ=f_{avg}×D_{P} Equation 2

Using the per-person duration of media exposure (Dₘ) of equation 2 above, a total duration of exposure (D_{mT}) for all of the 200 participants represented in the table 500 can be determined by multiplying the per-person duration of media exposure (Dₘ) by the total census count (C_{T}) (i.e., D_{mT}=Dₘ×C_{T}). The total duration of exposure (D_{mT}) can then be imputed onto a larger audience including all of the members of the fitness environment 100 to determine the total duration of exposure for all of the members.

In other example implementations, weighted visitation frequencies (Wf) can be used to determine exposures to media in the fitness environment 100. For example, turning to FIG. 6, the example table 600 stores data that can be used to weight visitation frequencies based on the probabilities that each person in the total census (C_{T}) of 200 people is likely to be present on any given day. The example table 600 includes a transactions column 602 similar to the transactions column 502 of FIG. 5, a count column 604 similar to the count column 504 of FIG. 5, and a percentage of total count column 606 similar to the percentage of total count column 506 of FIG. 5. In addition, the example table 600 includes a probability column 608 and a weighted count column 610. The probability column 608 stores probability values (Pᵢ) corresponding to respective ones of the visitation frequencies (fᵢ) indicative of the probability that for each person present at the fitness environment 100 on any given day for a particular visitation frequency, there are likely a number of other people (represented by the probability values (Pᵢ)) that will also be present for that same visitation frequency. Thus, referring to the first entry of the probability column 608, for each person represented by the count (Cᵢ) corresponding to a frequency of one, there are likely seven people (Pᵢ=7) that will be present the same number of times. The weighted count column 610 stores weighted count values (WCᵢ) indicative of how much weight each of the counts (Cᵢ) is given based on the probabilities (Pᵢ) that the persons corresponding to those counts will be at the fitness environment 100 on any given day. The data stored in the table 600 can be used to determine the average weighted visitation frequency (Wf_{avg}) of the typical person in the total 200-count census based on equation 3 below.

$${Wf}_{avg} = \frac{{\sum }_{i = 1}^{n} {f}_{i} \times {WC}_{i}}{{\sum }_{i = 1}^{n} {WC}_{i}} \qquad Equation 3$$

The average weighted visitation frequency (Wf_{avg}) of equation 3 is the average frequency of people that visited a particular location over a given period (e.g., a week) and is weighted based on the probability that there are likely to be a number of other people (represented by the probability values (Pᵢ)) that will also be present for that same visitation frequency. Thus, unlike equation 1, equation 3 applies relatively higher weights to counts (Cᵢ) associated with lower visitation frequencies so that counts (Cᵢ) associated with higher visitation frequencies do not significantly skew the resulting visitation frequency. As shown in equation 3 above, the average weighted visitation frequency (Wf_{avg}) is determined by determining the sum of the products of the visitation frequencies (fᵢ) multiplied by the weighted counts (WCᵢ) for each of the seven days (n=7) in the seven day period of transactions

$$( {\sum }_{i = 1}^{n} {f}_{i} \times {WC}_{i} )$$

and dividing that sum by the sum of the weighted counts (WCᵢ) for each of the seven days (n)

$$( {\sum }_{i = 1}^{n} {WC}_{i} ) .$$

Using the data in the illustrated example of FIG. 6, the average weighted visitation frequency (Wf_{avg}) is equal to 3.28. The average weighted visitation frequency (Wf_{avg}) can then be multiplied by the predetermined typical dwell time or duration of exposure (Dₚ) as shown in Equation 4 below to determine a weighted per-person duration of media exposure (WDₘ).

WDₘ=Wf_{avg}×Dₚ Equation 4

Using the weighted per-person duration of media exposure (WDₘ) of equation 4 above, a total weighted duration of exposure (WD_{mT}) for all of the 200 participants represented in the table 600 can be determined by multiplying the weighted per-person duration of media exposure (WDₘ) by the total census count (C_{T}) (i.e., WD_{mT}=WDₘ×C_{T}). The total weighted duration of exposure (WD_{mT}) can then be imputed onto a larger audience including all of the members of the fitness environment 100 to determine the total weighted duration of exposure for all of the members.

In the illustrated examples described above in connection with FIGS. 1, 5, and 6, the advertisement/informational media for which the exposure durations (Dₘ, D_{mT}) and weighted exposure durations (WDₘ, WD_{mT}) were determined are the media 110a and 110b of FIG. 1 because all of the 200 participants must have walked through the foyer 102 to enter the fitness environment 100. The same techniques described above can be used to determine average visitation frequencies (f_{avg}) and durations of exposure (Dₘ, D_{mT}) for others of the media 110c-h by using transaction information corresponding to respective ones of the other areas 104, 106, and 108 of the fitness environment 100.

Turning now to FIG. 2, another example environment for which the example methods and apparatus described herein can be used to measure audience exposure to advertisement/informational media is shown as a bar/dining establishment 200. The bar/dining establishment 200 includes a plurality of advertisement/informational media 202a-f. In the illustrated example, the advertisement/informational medium 202b is shown as a scrolling medium that changes its advertisement and/or information at periodic intervals and the media 202c-f are video delivery media. In the illustrated example, the bar/dining establishment 200 leases out or rents interactive gaming devices 204 that enable patrons of the establishment 200 to interactively participate in games (e.g., trivia games) presented via the video delivery media 200c-f. As shown, each of the interactive gaming devices 204 can be rented from a rental transaction station 206. When a person rents one of the interactive gaming devices 204, a transaction is recorded to represent that a person rented one of the devices 204 and participated in the games presented via the video delivery media 200c-f.

In the illustrated example of FIG. 2, durations of audience exposure to media are measured using the transactions (T_{G}) of the gaming devices 204 collected by the rental transaction station 206, a predetermined average duration (D_{G}) of game play for a typical gaming device 204, and the typical quantity of people per party (or party count) (P_{C}) having a gaming device 204. First, a total active exposure duration (D_{TA}) corresponding to the exposures of players having rented one of the gaming devices 204 can be determined by multiplying the number of transactions (T_{G}) by the predetermined average duration (D_{G}) of game play (i.e., D_{TA}=T_{G}×D_{G}). A total exposure duration (D_{T}) for active players and passive people (e.g., watchers, glancers, etc.) can then be determined by multiplying the total active exposure duration (D_{TA}) by the typical quantity of people per party (P_{C}) (i.e., D_{T}=D_{TA}×P_{C}). The total active exposure duration (D_{TA}) and the total exposure duration (D_{T}) are indicative of exposure durations to the advertisement/informational media 202a-f. That is, while people are playing an interactive game presented via the video delivery media 202c-f, they are also exposed to any advertisements presented via the video delivery media 202c-f in addition to being exposed to the advertisement/informational media 202a-b.

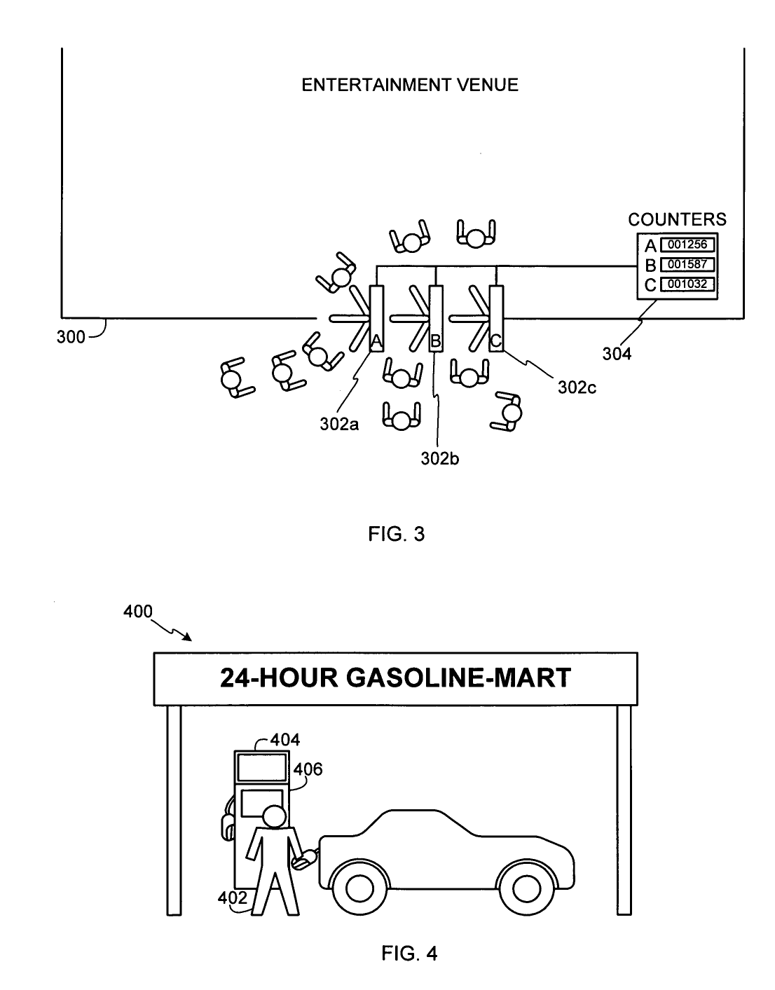

Turning to FIG. 3, an example entertainment venue 300 illustrates the use of turnstiles 302a-c for collecting transaction data. In the illustrated example, each of the turnstiles 302a-c transmits count increment signals to counters 304, and the counters 304 store the transaction counts for later use in determining durations of audience exposures to advertisement/informational media presented in the entertainment venue 300.

Turning now to FIG. 4, in the context of a gasoline station 400, when a person 402 is pumping gas, the person 402 can be exposed to an advertisement medium 404 (e.g., a video monitor) located proximate to a gas pump 406 that collects gas pump transaction information (e.g., number of gallons pumped, duration of pumping, demographic information of customers, etc.) For example, based on gas pump transactions for a twenty-four hour period, the example methods and apparatus can be used to determine the number of people that were present within an exposure distance to the gas pump advertisement medium 404, the duration for which each person was present at that location, and the demographic composition of the people. In some example implementations, some or all of this transaction information may be alternatively collected using survey questionnaires such that some or none of the transaction data is collected by the gas pump, but is instead collected using in-person, paper-based, or electronic-based surveying techniques. Based on this information, the example methods and apparatus can determine a duration of audience exposure to media based on the total number of minutes for which people were exposed to the gas pump advertisement medium 404.

In the illustrated example of FIG. 4, sales transaction information of people that pumped gas is used to determine the number of people that were actually exposed to the medium 404 and the duration of audience exposure, whereas using people counts alone would not reflect the duration for which people were exposed nor how many of the people were actually exposed to the medium 404. For example, if each of 48 people pumped gas for five minutes at the gas pump 406 and a particular advertisement ran every 30 minutes on the video monitor medium 404, then although all 48 people were exposed to the video monitor medium 404, only four of those people would have been exposed to the advertisement that ran every 30 minutes.

The duration of exposure can be reported as a performance measure of the gas pump advertisement medium 404, instead of only reporting the number of people that were exposed to the gas pump advertisement medium 404 as a whole within a 24-hour period. In this manner, parties interested in the exposure measurements can estimate the exposure that was achieved for a particular advertisement that ran on the gas pump advertisement medium 404.

Predetermined durations of exposure for a typical gasoline pump transaction can be based on a sale transaction as a whole or on the quantity of gasoline pumped. For example, a predetermined duration of exposure for a typical gasoline pump transaction may be set to four minutes using the typical dwell time of a customer regardless of the quantity of gasoline pumped. However, where sizes of vehicles and quantities of gasoline pumped by different customers differs significantly from transaction to transaction, the accuracy of exposure duration can be increased by basing the typical dwell time of a customer on the quantity of gasoline pumped. For example, a predetermined duration or dwell time of two minutes may be associated with each four gallons pumped. In this manner, if a sales transaction indicates that a person pumped eight gallons, the predetermined duration of exposure for that transaction would be four minutes.

In some example implementations, the example methods and apparatus can use sales transactional data of the gas pump 406 in connection with survey data to identify times when persons located within an exposure distance of the gas pump advertisement medium 404 did not pay attention, observe, or otherwise consume the information presented via the advertisement medium 404. For example, if 100 people pumped gas and only 75 of those persons observed the gas pump advertisement medium 404, while the other 25 persons did not (e.g., they sat in their vehicles or left their vehicles to purchase something at the gas station store), the duration of audience exposure to the medium 404 for those people should only be based on 75 people. Thus, in response to survey questions, each of the 100 people can respond by indicating whether they observed the gas pump advertisement medium 404 and the duration of the observation or exposure. If 75% of the people responded as having observed the advertisement medium 404, 75% of the sales transaction data for the gas pump 406 can be attributed to exposure to the advertisement medium 404. The example methods and apparatus can also be used to determine the demographic composition of the audience to particular advertisement spots or times of day based on the demographic composition associated with all transactions collected during the survey and the durations of stay or view.

In any of the example implementations described above in connection with FIGS. 1-4, comparative measures of performance or advertisement efficiency can be determined based on total actual minutes of exposure and potential minutes of exposure. To generate a comparative measure of performance, the example methods and apparatus can use a total minutes parameter (M_{T}) and a potential minutes parameter (M_{P}). The total minutes parameter (M_{T}) is the number of minutes for which people were actually exposed to and/or observed an advertisement medium and the potential minutes parameter (M_{P}) is the number of minutes available for exposure to the advertisement medium. For the 24-hour gasoline station 400 of FIG. 4, the potential minutes parameter (M_{P}) would be set equal to 1,440 minutes (i.e., 24 hours×60 minutes), while for an 18-hour grocery store, the potential minutes parameter (M_{P}) would be set equal to 1,080 minutes. In some example implementations, the total minutes may be scaled based on a known or estimated number of people that were in a particular location while that location was open for business. For example, although the gasoline station 400 is open for 24 hours, if only 100 people pumped gas for five minutes each during that 24-hour period (as determined based on gas pumping transaction data), the potential minutes would be reduced to 500 minutes (i.e., 100 people×5 minutes), while the total minutes would be based on the subset of the 100 people (e.g., 75 people) that indicated they actually observed or were exposed to (e.g., did not sit in their car or leave the gas pump area during pumping) the advertising medium 404. In other example implementations, the potential minutes may alternatively be based on a particular day part of interest or a day part known to have the most traffic. After determining the total minutes (M_{T}) and the potential minutes (M_{P}), a comparative performance measure can be determined by dividing the total minutes (M_{T}) by the potential minutes (M_{P}). In this manner, an advertiser interested in the durations of audience exposure can determine which of its advertisements have better exposure performance than others.

In yet other example implementations, the total minutes (M_{T}) and the potential minutes (M_{P}) can be calculated to take into account the possibility of an advertisement/exposure medium to be exposed to multiple people simultaneously. For example, while a medium available for exposure for 24 hours to only one person at a time has a potential minutes value (M_{P}) of 1,440 minutes, a medium available for exposure for 24 hours to multiple people simultaneously would have a potential minutes value (M_{P}) of 1,440 minutes multiplied by the number of people that could simultaneously contribute to exposure. Thus, in such instances, the potential minutes value (M_{P}) for a medium can be determined by multiplying the medium's duration of availability for exposure by a factor representative of the number of people that could contribute minutes of exposure during the medium's availability. The total minutes (M_{T}) could also be determined based on the number of people that were actually exposed to the medium, some of which were exposed simultaneously.

In some example implementations, a total traffic count can be estimated from transactions or sample based counts. The total traffic count is then multiplied by a factor that relates to the relationship of time spent (or dwell time) to a rotational period of an advertisement schedule in the context of advertisements that periodically change such as, for example, in connection with the scrolling advertisement medium 202b of FIG. 2 and the gas pump video advertisement medium 404 of FIG. 4. In this fashion, if the average person spent 30 minutes in proximity to an advertisement medium and an advertisement rotation was four times an hour, the average person would get a factor of two (i.e., they would have been exposed twice to the rotated advertisement). If the person spent 15 minutes and the advertisement rotation was twice an hour, then the factor would be 0.5 (i.e., only half the people would have been exposed to the rotated advertisement).

An estimation can be made from the transactions/sample based counts to indicate that 10,000,000 people were in proximity to the advertisement medium of interest in a day. Thus, if the dwell time of each person was 30 minutes where an advertisement rotation was four times per hour, there would have been 20,000,000 gross exposures. Where four advertisement spots are rotated each hour, 96 advertisement spots occur during a one-day period (i.e., 4×24 hours). Therefore, the average spot audience in this instance (30 minutes of dwell time and four spots of rotation per hour) would be 20,000,000/96 or 208,333. If the dwell time for each person was 15 minutes where an advertisement rotation was twice per hour, there would have been 5,000,000 gross exposures. Where two advertisement spots are rotated each hour, 48 spots occur during a one-day period (i.e., 2×24 hours). In this instance (15 minutes of dwell time and two rotations per hour), the average spot audience would be 5,000,000/48 or 104,166. In these example scenarios, the average spot/minute audience facilitates comparability across networks and media and can ease the use of the information in media buying systems.

In other example implementations, an average spot audience for a particular location could be determined by dividing the total minutes of exposure (M_{T}) by the potential minutes of exposure (M_{P}) and multiplying the resulting quotient

$$( \frac{{M}_{T}}{{M}_{P}} )$$

by the estimated number of people that were at that location on a typical day. Thus, if 100,000 people pumped gas and survey data showed that, on average, each of those persons pumped gas for 10 minutes out of a potential 1440 minutes of exposure that could be contributed by each person, then the estimated number of people is equal to 100,000, the total minutes of exposure (M_{T}) is equal to 1,000,000 (i.e., 100,000 people×10 minutes of actual exposure per person), and the potential minutes of exposure (M_{P}) is 144,000,000 (i.e., 100,000 people×1440 minutes of potential exposure per person). Thus, the average spot audience is equal to the number of people pumping gas during the average minute, which in the illustrated example is equal to 690 people

$$( i . e . , \frac{{M}_{T}}{{M}_{P}} \times estimated number of people = \frac{1 \text{,} 000 \text{,} 000}{144 \text{,} 000 \text{,} 000} \times 100 \text{,} 000 ) .$$

In this example implementation, if a spot were presented every 15 minutes, there would be a total of 96 spots during a 24-hour period

$$( i . e . , \frac{60 minutes}{15 minutes per spot} \times 24 hours = 96 spots )$$

for a total gross impression of 66,240 (i.e., 96 spots×690 people=66,240 gross impressions). The above described techniques of determining average spot audiences for dynamically changing advertisements can be used in connection with any of the methods described herein of monitoring audience exposure to media.

Although the example methods and apparatus are described above in connection with transaction data from fitness centers, bar/dining establishments, entertainment venues, and gasoline stations, other place-based transaction data can also be used. For example, in a retail store, product sales transactions can be used to determine where people were located in the retail store (e.g., if a person bought milk, the person passed through the dairy aisle and was exposed to advertisements therein for an average duration of 30 seconds). In an amusement park, the transaction data may be turnstile counter data to determine the number of people that walked through different entrances of the amusement park and were likely exposed to advertisements at those entrances. If tracking is performed at individual rides, the data can have further granularity to individual amusement park areas and/or attractions and/or the advertisements associated with those areas and/or attractions.

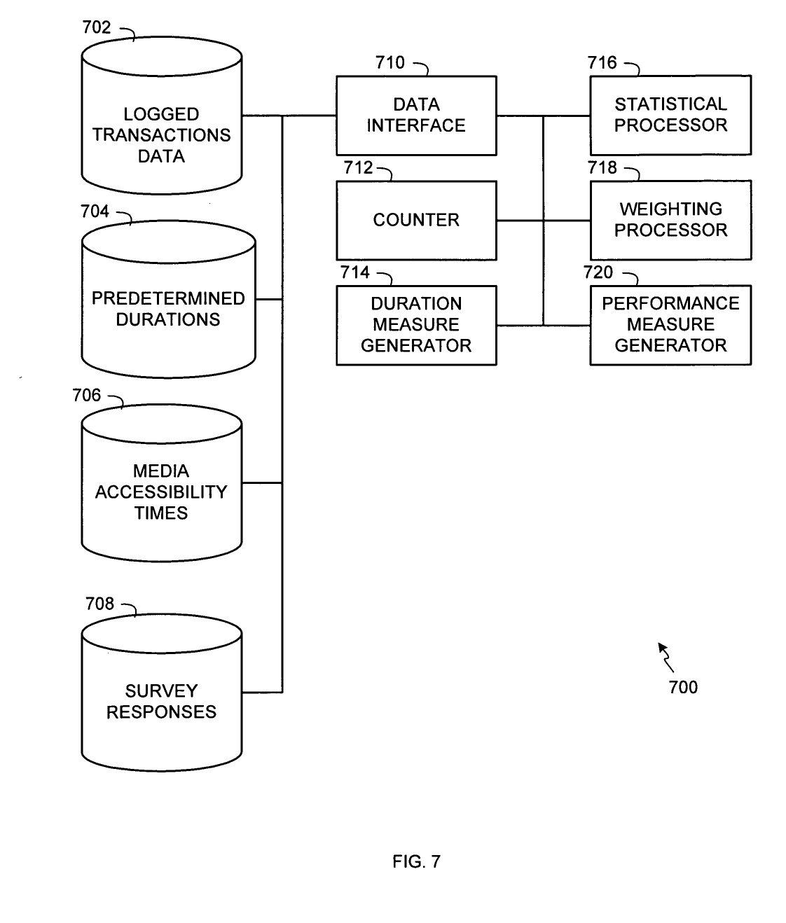

FIG. 7 is a block diagram of an example apparatus 700 that may be used to measure audience exposure to advertisement/informational media as described herein. In the illustrated example, the example apparatus 700 includes a logged transactions data structure 702, a predetermined durations data structure 704, a media accessibility times data structure 706, a survey responses data structure 708, a data interface 710, a counter 712, a duration measure generator 714, a statistical processor 716, a weighting processor 718, and a performance measure generator 720. The example apparatus 700 may be implemented using any desired combination of hardware, firmware, and/or software. For example, one or more integrated circuits, discrete semiconductor components, and/or passive electronic components may be used. Thus, for example, any of the logged transactions data structure 702, the predetermined durations data structure 704, the media accessibility times data structure 706, the survey responses data structure 708, the data interface 710, the counter 712, the duration measure generator 714, the statistical processor 716, the weighting processor 718, and/or the performance measure generator 720, or parts thereof, could be implemented using one or more circuit(s), programmable processor(s), application specific integrated circuit(s) (ASIC(s)), programmable logic device(s) (PLD(s)), field programmable logic device(s) (FPLD(s)), etc.

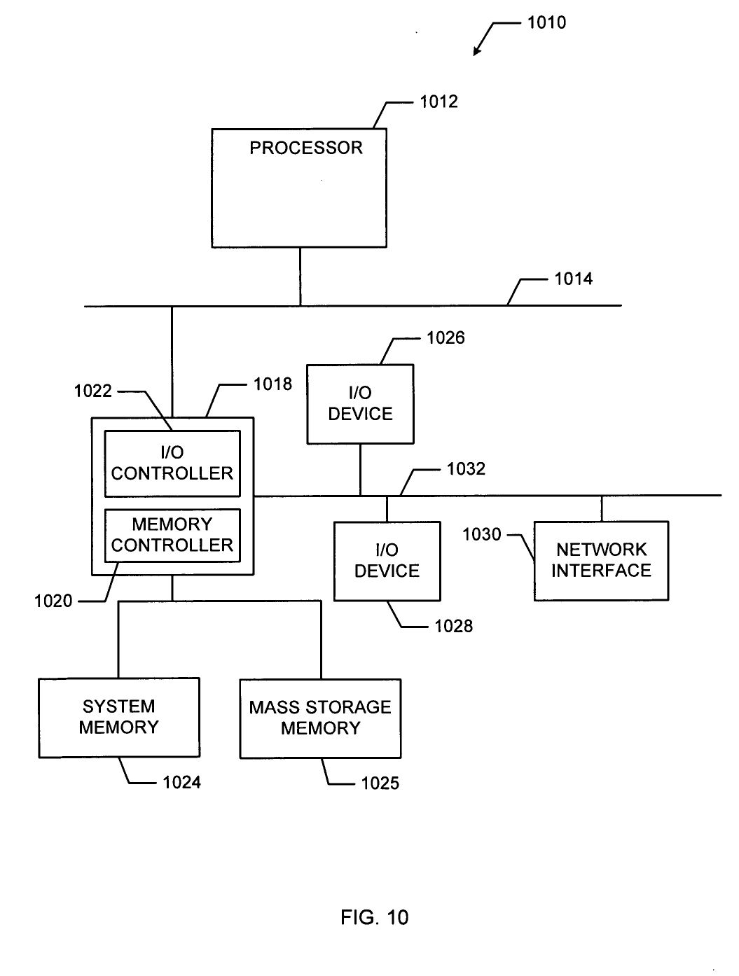

Some or all of the logged transactions data structure 702, the predetermined durations data structure 704, the media accessibility times data structure 706, the survey responses data structure 708, the data interface 710, the counter 712, the duration measure generator 714, the statistical processor 716, the weighting processor 718, and/or the performance measure generator 720, or parts thereof, may be implemented using instructions, code, and/or other software and/or firmware, etc. stored on a machine accessible medium and executable by, for example, a processor system (e.g., the example processor system 1010 of FIG. 10). When any of the appended claims are read to cover a purely software and/or firmware implementation, at least one of the logged transactions data structure 702, the predetermined durations data structure 704, the media accessibility times data structure 706, the survey responses data structure 708, the data interface 710, the counter 712, the duration measure generator 714, the statistical processor 716, the weighting processor 718, and/or the performance measure generator 720 is hereby expressly defined to include a tangible medium such as a memory, DVD, CD, etc. storing the software and/or firmware.

The logged transactions data structure 702 is provided to store transaction data collected using, for example, the card swipe station 112 of FIG. 1, the people counters 116a-d of FIG. 1, the rental transaction station 206 of FIG. 2, the turnstile counters 304 of FIG. 4, the gas pump 406 of FIG. 4, and/or survey responses indicative of visitations to particular environments or establishments. The predetermined durations data structure 704 is provided to store predetermined typical dwell times or durations of exposure that can be attributed to typical transactions stored in the logged transactions data structure 702.

The media accessibility times data structure 706 is used to store durations of operation or accessibility of environments, establishments, or locations at which advertisement/informational media are located. For example, the media accessibility times data structure 706 can store data indicative of 24 hours for the gasoline station 400 of FIG. 4 to indicate that the gasoline station 400 is open 24 hours per day such that the advertisement medium 404 is accessible for exposure during the entire 24 hours of operation. In some instances, the media accessibility times data structure 706 can also store subset hours of accessibility descriptive of times or day parts during which different amounts of traffic (e.g., heavier traffic, lighter traffic, etc.) flow through a particular establishment or environment. In this manner, exposure measurements can be performed for particular day parts of interest.

The survey responses data structure 708 is used to store survey response information provided by participants in marketing studies used to implement the example methods and apparatus described herein. For example, the survey responses may be indicative of whether participants paid attention to particular advertisement/informational media.

The data interface 710 is configured to retrieve data from and store data in the data structures 702, 704, 706, and 708. The counter 712 is configured to determine total counts of people and/or transactions based on data stored in the logged transactions data structure 702 and/or the survey responses data structure 708. In some instances, the counter 712 may generate people counts that are directly attributable to each of a plurality of stored transactions. In other instances, the counter may use a plurality of stored transactions for a particular day part (or other time period) to estimate counts during other day parts. For example, in the context of the fitness environment 100, the people detector 116b may generate a person count of the cardio area 104 proximate to the video delivery medium 110f at a particular day part, and the counter 712 may multiply the person count by a number of day parts to determine a representative person count value for all of the day parts. In this manner, the counter 712 can determine the quantity of persons present proximate to the video delivery medium 110f based on the representative person count value collected by the people detector 116b for one representative day part.

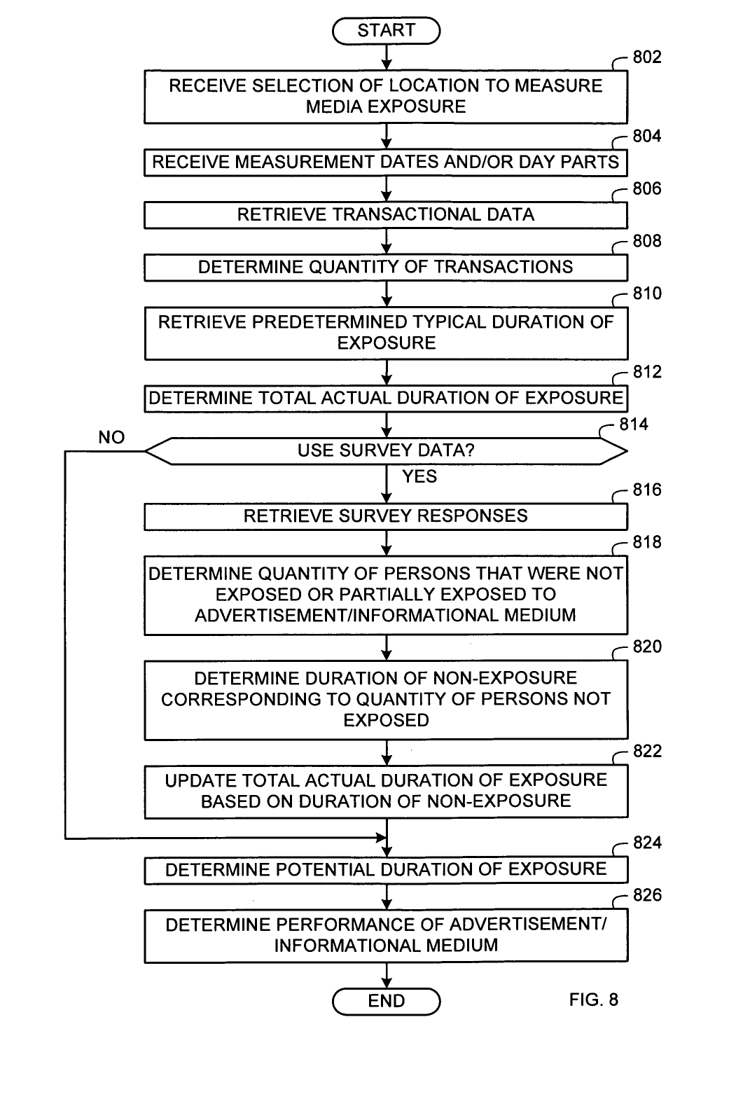

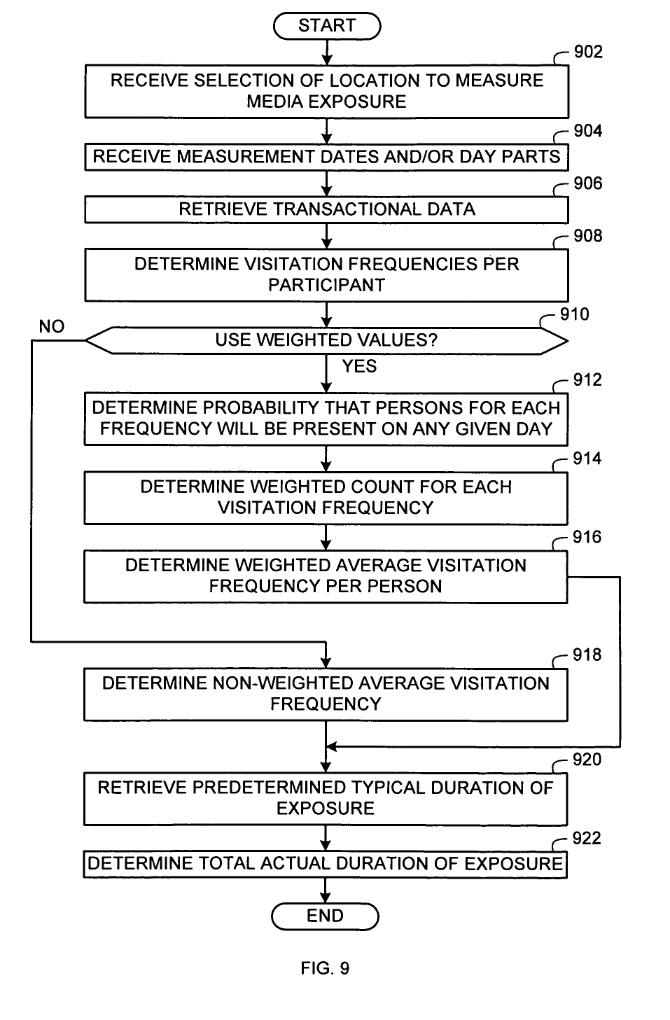

The duration measure generator 714 is configured to determine durations of audience exposure to media. The statistical processor 716 is configured to determine probabilities of presences of people at particular locations. The weighting processor 718 is configured to determine weighting values in connection with people counts or frequencies of visitation based on the probabilities determined by the statistical processor 716. The performance measure generator 720 is configured to determine performance or efficiency measures for different advertisement/informational media based on total actual minutes of exposure (M_{T}) and potential minutes of exposure (M_{P}). In some example implementations, the performance measure generator 720 is also configured to compare performance measures of different advertisement/informational media to one another. Further functionality and operations of the example apparatus 700 are described below in connection with the example methods of FIGS. 8 and 9.

Flow diagrams depicted in FIGS. 8 and 9 are representative of machine readable instructions that can be executed to implement the example apparatus 700 of FIG. 7 to measure audience exposure to advertisement/informational media. The example processes of FIGS. 8 and 9 may be performed using a processor, a controller and/or any other suitable processing device. For example, the example processes of FIGS. 8 and 9 may be implemented in coded instructions stored on a tangible medium such as a flash memory, a read-only memory (ROM) and/or random-access memory (RAM) associated with a processor (e.g., the example processor 1012 discussed below in connection with FIG. 10). Alternatively, some or all of the example processes of FIGS. 8 and 9 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 8 and 9 may be implemented manually or as any combination(s) of any of the foregoing techniques, for example, any combination of firmware, software, discrete logic and/or hardware. Further, although the example processes of FIGS. 8 and 9 are described with reference to the flow diagrams of FIGS. 8 and 9, other methods of implementing the processes of FIGS. 8 and 9 may be employed. For example, the order of execution of the blocks may be changed, and/or some of the blocks described may be changed, eliminated, sub-divided, or combined. Additionally, any or all of the example processes of FIGS. 8 and 9 may be performed sequentially and/or in parallel by, for example, separate processing threads, processors, devices, discrete logic, circuits, etc.

Turning to FIG. 8, the illustrated flow diagram is representative of an example process that can be used to measure audience exposure to one or more advertisement/informational media (e.g., any of the advertisement/informational media depicted in connection with any of the environments of FIGS. 1-4 or any other environment) and the performance or efficiency of the advertisement/informational medium. Initially, the data interface 710 of the apparatus 700 of FIG. 7 receives a selection of a location or environment in which to measure media exposure (block 802). In the illustrated example, the location is selected as the gas station 400 of FIG. 4. The data interface 710 then receives one or more date(s) and/or day part(s) for which to determine exposure measures (block 804).

Based on the date(s) and/or day part(s) received at block 804, the data interface 710 retrieves transactional data from the logged transactions data structure 702 (block 806) for those date(s) and/or day part(s). The counter 712 (FIG. 7) determines the quantity of transactions (block 808). In the illustrated example, the quantity of transactions is representative of a person count indicative of the number of people that pumped gas at the gas pump 406 (FIG. 4). The data interface 710 then retrieves a predetermined typical duration of exposure (block 810) from the predetermined durations data structure 704 (FIG. 7). The predetermined duration of exposure may be a duration value representative of a duration per transaction (e.g., five minutes per each gasoline sale transaction) or a duration per a quantity of gasoline pumped (e.g., two minutes for each four gallons pumped).

The duration measure generator 714 (FIG. 7) determines the total actual duration of exposure (block 812) by, for example, multiplying the predetermined duration of exposure retrieved at block 810 by the quantity of transactions determined at block 808. In the illustrated example, the total actual duration of exposure is measured using minutes such that the total actual duration of exposure is a total actual minutes of exposure (M_{T}). The apparatus 700 then determines whether survey data is to be used (block 814). In the illustrated example, survey data stored in the survey responses data structure 708 is indicative of whether participants that pumped data actually paid attention to the gas pump advertisement medium 404 (FIG. 4). If such survey data is available and the apparatus 700 is configured to use the survey data (block 814), the data interface 710 retrieves the survey data (block 816) from the survey response data structure 708. The counter 712 determines the quantity of persons that were not exposed or partially exposed to the advertisement/informational medium 404 (block 818) based on the survey data. The duration measure generator 714 then determines the duration of non-exposure corresponding to the quantity of persons represented in the survey data as not being exposed to or only being partially exposed to the medium 404 (block 820). The duration measure generator 714 then updates the total actual duration of exposure (M_{T}) based on the duration of non-exposure (block 822) by subtracting the duration of non-exposure determined at block 820 from the total actual duration of exposure (M_{T}) determined at block 812.

After updating the total actual duration of exposure (M_{T}) (block 822) or if the apparatus 700 determined that it is not to use survey data (block 814), the duration measure generator 714 determines the potential duration of exposure (M_{P}) (block 824) of the gas pump advertisement/informational medium 404. In the illustrated example, the duration measure generator 704 determines the potential duration of exposure (M_{P}) by determining the duration for which the gas pump advertisement/informational medium 404 is accessible for exposure to people based on the date(s) and/or day part(s) received at block 804 and the media accessibility times stored in the media accessibility data structure 706. The performance measure generator 720 then determines the performance (or efficiency) of the advertisement/informational medium 404 (block 826) by dividing the total actual duration of exposure (M_{T}) by the potential duration of exposure (M_{P}) (i.e., advertisement/informational medium performance=M_{T}/M_{P}). Although not shown in the flow diagram of FIG. 8, the performance measure generator 720 may also associate the performance of the advertisement/informational medium 404 with demographic information associated with the transaction data in the logged transactions data. The example process of FIG. 8 then ends.

Turning now to FIG. 9, the illustrated flow diagram is representative of another example process that can be used to measure audience exposure to one or more advertisement/informational media (e.g., any of the advertisement/informational media depicted in connection with any of the environments of FIGS. 1-4 or any other environment). Initially, the data interface 710 of the apparatus 700 of FIG. 7 receives a selection of a location or environment in which to measure media exposure (block 902). In the illustrated example, the location is selected as the fitness environment 100 of FIG. 1 and may be a specific one of the areas 102, 104, 106, and 108 of the fitness environment 100. The data interface 710 then receives one or more date(s) and/or day part(s) for which to determine exposure measures (block 904). In the illustrated example, the dates to be measured cover a seven-day period

Based on the date(s) and/or day part(s) received at block 904, the data interface 710 retrieves transactional data from the logged transactions data structure 702 (block 906) for those date(s) and/or day part(s). The transactional data can correspond to membership card swipes collected using the card swipe station 112, person counts collected using the people detectors 116a-d, and/or survey response data. In the illustrated example, the transactional data is indicative of how many times per seven-day period each participant visited the fitness environment. The counter 712 (FIG. 7) determines the visitation frequencies (fᵢ) per participant (block 908) for the seven-day period based on the transactional data.

The apparatus 700 determines whether to use weighted values (block 910). In the illustrated example, weighted values take into account the probability that any one participant will be in the fitness environment 100 on any given day during the seven-day period as described above in connection with the example table 600 of FIG. 6. If the apparatus 700 determines that it should use weighted values (block 910) (e.g., a user has configured the example apparatus 700 to use weighted values), the statistical processor 716 (FIG. 7) determines the probability (Pᵢ) that persons corresponding to each visitation frequency (fᵢ) will be present on any given day (block 912). In the illustrated example, the statistical processor 716 determines the probability values (Pᵢ) for each visitation frequency (fᵢ) as discussed above in connection with FIG. 6. The probabilities (Pᵢ) for all visitation frequencies (fᵢ) can be stored in the probability column 608 of FIG. 6. The weighting processor 718 (FIG. 7) then determines the weighted count (WCᵢ) for each visitation frequency (fᵢ) (block 914) as described above in connection with FIG. 6. The weighted processor 718 (or the statistical processor 716) then determines the average weighted visitation frequency (Wf_{avg}) (block 916) as described above in connection with equation 3.

If at block 910, the apparatus 700 determines that it should not use weighted values, control passes from block 910 to block 918 (skipping blocks 912, 914, and 916). At block 918, the statistical processor 716 determines the average non-weighted visitation frequency (f_{avg}) (block 918) as described above in connection with equation 1. After the apparatus 700 determines the average weighted visitation frequency (Wf_{avg}) (block 916) or the average non-weighted visitation frequency (f_{avg}) (block 918), the data interface 710 then retrieves a predetermined typical duration of exposure (block 920) from the predetermined durations data structure 704 (FIG. 7). The predetermined duration of exposure may be a duration value representative of a duration for which a person was present at a particular one of the locations 102, 104, 106, and 108 of the fitness environment 100. The one of the locations 102, 104, 106, and 108 with which the retrieved predetermined typical duration is associated depends on which of the locations 102, 104, 106, and 108 the transactional data retrieved at block 906 is associated. If the transactional data is based on membership card swipes, then the predetermined typical duration is the duration for which a typical person dwells or stays in the foyer 102. If the transactional data is based on surveys of people that exercised in the cardio area 104, then the predetermined typical duration is the duration for which a typical person exercises in the cardio area 104.

The duration measure generator 714 (FIG. 7) determines the total actual duration of exposure (block 922) to one or more of the advertisement/informational media 110a-h corresponding to the location selection received at block 902 by, for example, multiplying the predetermined duration of exposure retrieved at block 920 by the weighted visitation frequency (Wf_{avg}) or the average non-weighted visitation frequency (f_{avg}). In the illustrated example, the total actual duration of exposure is measured using minutes such that the total actual duration of exposure is a total actual minutes of exposure (M_{T}). The example process of FIG. 9 is then ended.

Although not shown in FIG. 9, in some example implementations, the performance of the one or more of the advertisement/informational media 110a-h may be determined as described above in connection with blocks 824 and 826 of FIG. 8 based on the duration for which the one or more of the advertisement/informational media 110a-h is accessible for audience exposure. Also, although not shown in FIG. 8 or 9, the duration measure generator 714 may also multiply the actual minutes of exposure (M_{T}) by an exposure factor when the advertisement/informational media of interest is one that periodically or aperiodically changes the advertisement or information displayed (e.g., the scrolling medium 202b of FIG. 2 and/or any of the video delivery media of FIGS. 1, 2, and 4). As discussed above, the exposure factor relates to the relationship of time spent (or dwell time) to a rotational period of an advertisement schedule in the context of advertisements that periodically change so that exposure duration values (e.g., the actual minutes of exposure (M_{T})) are representative of persons having been duplicatively exposed and/or partially exposed to particular dynamically changing media.

FIG. 10 is a block diagram of an example processor system that may be used to implement some or all of the example methods and apparatus described herein. As shown in FIG. 10, the processor system 1010 includes a processor 1012 that is coupled to an interconnection bus 1014. The processor 1012 may be any suitable processor, processing unit or microprocessor. Although not shown in FIG. 10, the system 1010 may be a multi-processor system and, thus, may include one or more additional processors that are identical or similar to the processor 1012 and that are communicatively coupled to the interconnection bus 1014.

The processor 1012 of FIG. 10 is coupled to a chipset 1018, which includes a memory controller 1020 and an input/output (I/O) controller 1022. As is well known, a chipset typically provides I/O and memory management functions as well as a plurality of general purpose and/or special purpose registers, timers, etc. that are accessible or used by one or more processors coupled to the chipset 1018. The memory controller 1020 performs functions that enable the processor 1012 (or processors if there are multiple processors) to access a system memory 1024 and a mass storage memory 1025.

The system memory 1024 may include any desired type of volatile and/or non-volatile memory such as, for example, static random access memory (SRAM), dynamic random access memory (DRAM), flash memory, read-only memory (ROM), etc. The mass storage memory 1025 may include any desired type of mass storage device including hard disk drives, optical drives, tape storage devices, etc.

The I/O controller 1022 performs functions that enable the processor 1012 to communicate with peripheral input/output (I/O) devices 1026 and 1028 and a network interface 1030 via an I/O bus 1032. The I/O devices 1026 and 1028 may be any desired type of I/O device such as, for example, a keyboard, a video display or monitor, a mouse, etc. The network interface 1030 may be, for example, an Ethernet device, an asynchronous transfer mode (ATM) device, an 802.11 device, a DSL modem, a cable modem, a cellular modem, etc. that enables the processor system 1010 to communicate with another processor system.

While the memory controller 1020 and the I/O controller 1022 are depicted in FIG. 10 as separate functional blocks within the chipset 1018, the functions performed by these blocks may be integrated within a single semiconductor circuit or may be implemented using two or more separate integrated circuits.

Although the above description refers to the flowcharts as being representative of methods, those methods may be implemented entirely or in part by executing machine readable instructions. Therefore, the flowcharts are representative of methods and machine readable instructions.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

1. A method to monitor media exposure in a public establishment, comprising:
determining a duration of exposure to an information medium based on transaction information associated with access to a public establishment;
determining a first duration value based on the duration of exposure;
determining a second duration value indicative of a duration for which the information medium is accessible within the public establishment; and
determining an exposure performance value based on the first and second duration values indicative of an exposure performance of the information medium.

2. A method as defined in claim 1, wherein determining the duration of exposure further comprises setting the duration of exposure equal to a predetermined duration associated with an occurrence of a transaction represented by the transaction information.

3. A method as defined in claim 1, wherein the transaction information is at least one of gasoline sales transaction data, retail sales data, restaurant sales data, turnstile count data, or membership card transaction data.

4. A method as defined in claim 1, wherein determining the duration of exposure comprises obtaining a third duration associated with performing at least one activity represented by the transaction information and setting the duration of exposure equal to the third duration.

5. A method as defined in claim 4, wherein the activity is one of purchasing a product, passing through a turnstile, scanning a membership card, or pumping gasoline.

6. A method as defined in claim 1, wherein determining the first duration value comprises summing the duration of exposure and at least a second duration of exposure associated with at least a second person.

7. A method as defined in claim 1, wherein determining the duration of exposure comprises receiving survey information indicative of whether a person was attentive to the information medium.

8. A method as defined in claim 1, wherein determining the duration of exposure is based on at least one of a duration of presence proximate to the information medium or a periodicity of presentation of a spot via the information medium.

9. A method as defined in claim 8, wherein the spot is at least one of a video commercial, an audio commercial, or an automatically interchanged still-image.

10. A method as defined in claim 1, wherein determining the duration of exposure comprises multiplying an exposure factor by a duration of presence proximate to the information medium.

11. A method as defined in claim 10, further comprising determining the exposure factor based on a number of spots presented via the information medium to which the person was exposed.

12. A method as defined in claim 10, further comprising determining the exposure factor based on a time-based percentage of exposure to a portion of a spot presented via the information medium.

13. A method as defined in claim 1, wherein the information medium presents only one spot.

14. A method as defined in claim 1, further comprising associating the exposure performance value with demographic information.

15. A method as defined in claim 1, wherein the second duration is based on at least one of a duration of operation of the public establishment or a quantity of time during which people are present in the public establishment.

16. A method as defined in claim 1, further comprising determining a quantity of persons present proximate to the information medium, wherein determining the duration of exposure is based on a plurality of instances of exposure, each of which is associated with a respective one of the persons.

17. A method as defined in claim 16, wherein determining the quantity of persons is based on at least one of sales receipts, turnstile count data, membership card scan data, or person-acquired count data.

18. A method as defined in claim 16, wherein determining the quantity of persons present proximate to the information medium comprises determining the quantity of persons by:
generating a person count of an area proximate a second information medium at a particular portion of a day;
multiplying the person count by a number of portions of the day to determine a representative person count value; and
determining the quantity of persons present proximate to the information medium based on the representative person count value.

19. A method as defined in claim 1, wherein the information medium is an advertisement medium.

20. (canceled)

21. (canceled)

22. An apparatus to monitor media exposure in a public establishment, comprising:
a duration measure generator to determine a duration of exposure to an information medium based on transaction information associated with access to the public establishment and determine a first duration value based on the duration of exposure;
a data interface to obtain a second duration value indicative of a duration for which the information medium is accessible within the public establishment; and
a performance measure generator to determine an exposure performance value based on the first and second duration values indicative of an exposure performance of the information medium.

23. An apparatus as defined in claim 22, wherein the duration measure generator is to determine the duration of exposure by setting the duration of exposure equal to a predetermined duration associated with an occurrence of a transaction represented by the transaction information.

24. An apparatus as defined in claim 22, wherein the transaction information represents at least one of a gasoline sales transaction, a retail sales transaction, a restaurant sales transaction, a turnstile count, or a membership card transaction.

25. An apparatus as defined in claim 22, wherein determining the duration of exposure further comprises obtaining a third duration associated with performing at least one activity represented by the transaction information and setting the duration of exposure equal to the third duration.

26. (canceled)

27. An apparatus as defined in claim 22, wherein the duration measure generator is to determine the first duration value by summing the duration of exposure and at least a second duration of exposure associated with at least a second person.

28. An apparatus as defined in claim 22, wherein the duration measure generator is to determine the duration of exposure by receiving survey information indicative of whether a person was attentive to the information medium.

29. An apparatus as defined in claim 22, wherein the duration measure generator is to determine the duration of exposure based on at least one of a duration of presence proximate to the information medium or a periodicity of presentation of a spot via the information medium.

30. (canceled)

31. An apparatus as defined in claim 22, wherein the duration measure generator is to determine the duration of exposure by multiplying an exposure factor by a duration of presence proximate to the information medium.

32. An apparatus as defined in claim 31, wherein the exposure factor is based on a number of spots presented via the information medium to which the person was exposed.

33. An apparatus as defined in claim 31, wherein the exposure factor is based on a time-based percentage of exposure to a portion of a spot presented via the information medium.

34. (canceled)

35. An apparatus as defined in claim 22, wherein the performance measure generator is further to associate the exposure performance value with demographic information.

36. An apparatus as defined in claim 22, wherein the second duration is based on at least one of a duration of operation of the public establishment or a quantity of time during which people are present in the public establishment.

37. An apparatus as defined in claim 22, further comprising a counter to determine a quantity of persons present proximate to the information medium, wherein the duration measure generator is to determine the duration of exposure based on a plurality of instances of exposure, each of which is associated with a respective one of the persons.

38. (canceled)

39. An apparatus as defined in claim 37, further comprising a counter to determine the quantity of persons present proximate to the information medium by determining the quantity of persons by:
generating a person count of an area proximate a second information medium at a particular portion of a day;
multiplying the person count by a number of portions of the day to determine a representative person count value; and
determining the quantity of persons present proximate to the information medium based on the representative person count value.

40. An apparatus as defined in claim 22, wherein the information medium is an advertisement medium.

41. (canceled)

42. (canceled)

43. A machine accessible medium having instructions stored thereon that, when executed, cause a machine to:
determine a duration of exposure to an information medium based on transaction information associated with access to a public establishment;
determine a first duration value based on the duration of exposure;
determine a second duration value indicative of a duration for which the information medium is accessible within the public establishment; and
determine an exposure performance value based on the first and second duration values indicative of an exposure performance of the information medium.

44-63. (canceled)
